(19) United States
(12) Patent Application Publication
(10) Pub. No.: US 2017/0187827 A1
(43) Pub. Date: Jun. 29, 2017

(54) SYSTEM AND METHOD FOR PROVIDING SCHEDULE SHARE SERVICE BETWEEN USER EQUIPMENTS BY SCHEDULE SHARING APPLICATION

(71) Applicant: NORITER KOREA CO., LTD., Seoul (KR)

(72) Inventor: TAEKUN SHIN, Seoul (KR)

(21) Appl. No.: 14/995,919

(22) Filed: Jan. 14, 2016

(30) Foreign Application Priority Data
Dec. 23, 2015 (KR) 10-2015-0184765

(51) Int. Cl. H04L 29/08; G06Q 50/00; G06Q 10/10

(52) U.S. Cl. CPC H04L 67/325; H04L 67/18; H04L 67/22; G06Q 10/1095; G06Q 50/01

(57) ABSTRACT

A system and a method for performing schedule sharing between user terminals using a schedule sharing application are provided. The system includes a first user terminal configured to generate schedule information according to a schedule generation request input from a user of the first user terminal and to transmit and upload the generated schedule information using the schedule sharing application, a server configured to share the uploaded schedule information with one or more user terminals using the schedule sharing application, and a second user terminal configured to receive the shared schedule information using the schedule sharing application and to add the received schedule information to a schedule of a user of the second user terminal.

### CROSS-REFERENCE TO RELATED APPLICATIONS

A claim for priority under 35 U.S.C. §119 is made to Korean Patent Application No. 10-2015-0184765 filed Dec. 23, 2015, in the Korean Intellectual Property Office, the entire contents of which are hereby incorporated by reference.

### BACKGROUND

Embodiments of the inventive concepts described herein relate to a system and method for providing a schedule sharing service between user terminals using a schedule sharing application, and more particularly, relate to a system and method for allowing another user to receive shared schedule information and add the received schedule information to his or her schedule when a server shares the schedule information, generated according to a schedule generation request input from a user, using a schedule sharing application.

Recently, with the rapid progress of information and communication fields, mobile terminals have come into wide use. Therefore, a variety of technologies using mobile terminals have been developed and applied.

Particularly, there are technologies which receive schedules and manage the received schedules among various technologies using mobile terminals. These schedule management technologies mean technologies which allow users to recognize entered schedules in a corresponding date and time through alarms of mobile terminals when they enter the schedules in the mobile terminals.

Meanwhile, in general, schedules may be associated with only a user himself or herself. However, the schedules may be associated with other users or unspecified users.

In this case, a specific user who knows the schedule directly sends the schedule he or she knows to related other users or unspecified users. When receiving the schedule, each of the other users or the unspecified users enters the received schedule in his or her mobile terminal or calendar.

Therefore, since a variety of content of mobile terminals are rapidly shared through wireless communication according to the development of wireless communication technologies, there is a need for a system for sharing a schedule between one or more users or one or more user terminals according to these wireless communication technologies.

### SUMMARY

Embodiments of the inventive concepts provide a system for providing a schedule sharing service between user terminals using a schedule sharing application.

Embodiments of the inventive concepts provide a schedule sharing system for recommending a related schedule within a predetermined range from a location of a user among schedules shared by the schedule sharing application to him or her.

Embodiments of the inventive concepts provide a schedule sharing system for searching for a corresponding shared schedule among schedules shared by the schedule sharing application according to a keyword, a time range, and the like entered by the user.

One aspect of embodiments of the inventive concept is directed to provide a system for performing schedule sharing between user terminals using a schedule sharing application. The system may include a first user terminal configured to generate schedule information according to a schedule generation request input from a user of the first user terminal and to transmit and upload the generated schedule information using the schedule sharing application, a server configured to share the uploaded schedule information with one or more user terminals using the schedule sharing application, and a second user terminal configured to receive the shared schedule information using the schedule sharing application and to add the received schedule information to a schedule of a user of the second user terminal.

Another aspect of embodiments of the inventive concept is directed to provide a method for performing schedule sharing between user terminals using a schedule sharing application. The method may include generating, by a first user terminal, schedule information according to a schedule generation request input from a user of the first user terminal, transmitting and uploading, by a first user terminal, the generated schedule information to a server using the schedule sharing application, sharing, by the server, the uploaded schedule information with one or more user terminals using the schedule sharing application, and receiving, by a user of a second user terminal among the one or more user terminals, the shared schedule information using the schedule sharing application and adding, by the user of the second user terminal, the received schedule information to a schedule of the user of the second user terminal.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a drawing illustrating a wireless communication network environment according to an exemplary embodiment of the inventive concept;

FIGS. 2A and 2B are screens illustrating a schedule sharing application according to an exemplary embodiment of the inventive concept;

FIG. 3 is a flowchart illustrating a method for providing a schedule sharing service between user terminals using a schedule sharing application according to an exemplary embodiment of the inventive concept;

FIG. 4 is a screen illustrating a process of generating schedule information according to an exemplary embodiment of the inventive concept;

FIGS. 5A and 5B are screens illustrating a data type of generated schedule information according to an exemplary embodiment of the inventive concept;

FIG. 6 is a screen illustrating a method for performing schedule sharing between user terminals by a schedule sharing application according to an exemplary embodiment of the inventive concept;

FIG. 7 is a screen illustrating a method for performing schedule sharing between user terminals by a schedule sharing application according to another exemplary embodiment of the inventive concept;

FIG. 8 is a flowchart illustrating a method for recommending a schedule shared with a user terminal by a schedule sharing application according to an exemplary embodiment of the inventive concept;

FIGS. 9A to 9C are screens illustrating a method for allowing a user to search for a schedule shared with a user terminal by a schedule sharing application according to an exemplary embodiment of the inventive concept; and

FIG. 10 is a block diagram illustrating a configuration of a user terminal and a configuration of a server according to an exemplary embodiment of the inventive concept.

### DETAILED DESCRIPTION

Hereinafter, embodiments will be described in detail with reference to the accompanying drawings. The inventive concept, however, may be embodied in various different forms, and should not be construed as being limited only to the illustrated embodiments.

Rather, these embodiments are provided as examples so that this disclosure will be thorough and complete and will fully convey the concept of the inventive concept to those skilled in the art, and the inventive concept will only be defined by the appended claims.

In other instances, well-known structures and devices are not described, or are shown in block diagram form relative to core functions thereof to avoid obscuring the concept of the inventive concept. Also, like reference numerals denote like elements throughout the written description.

Throughout the specification, unless explicitly described to the contrary, the word “comprise” and variations such as “comprises” or “comprising” will be understood to imply the inclusion of stated elements but not the exclusion of any other elements.

Also, terms such as “unit” and “part”, which are described in the specification, means a unit of a comprehensive configuration that performs at least one function or operation. The “unit” and “part” are implemented with hardware, software, or combinations thereof. In addition, the singular forms “a”, “an” and “one” are intended to include the plural forms as well, unless the context clearly indicates otherwise.

Also, specific terms used in embodiments of the inventive concept are provided to help understanding of the inventive concept. Unless otherwise defined, all terms, including technical and scientific terms, used herein have the same meaning as commonly understood by one of ordinary skill in the art to which this inventive concept belongs. Such specific terms are changed to different forms without departing from the scope and spirit of the inventive concept.

Hereinafter, a description will be given in detail for exemplary embodiments of the inventive concept with reference to the accompanying drawings. Detailed description disclosed below together with the attached drawings is to describe exemplary embodiments of the inventive concept, not describing only exemplary embodiment of the inventive concept.

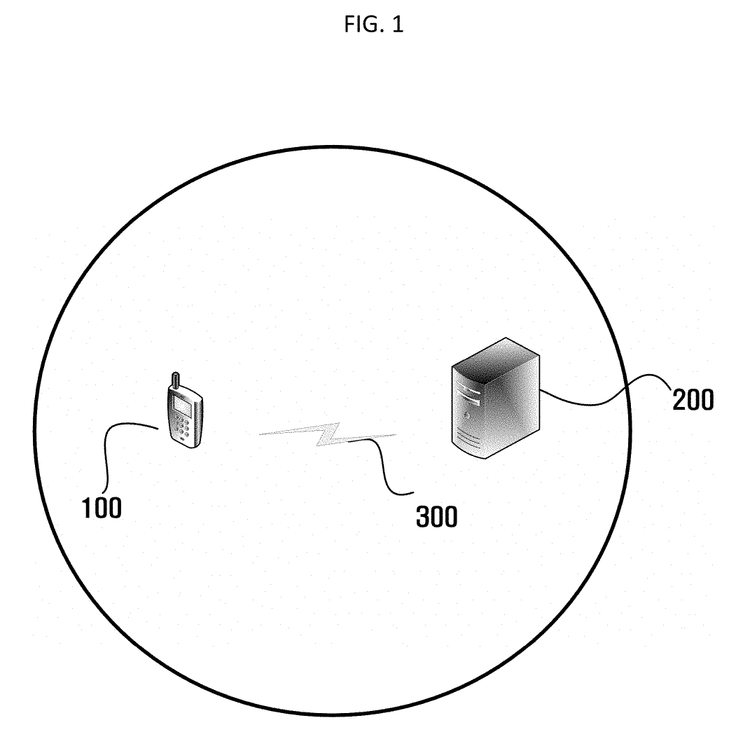

FIG. 1 is a drawing illustrating a wireless communication network environment according to an exemplary embodiment of the inventive concept.

Referring to FIG. 1, the wireless communication network environment according to an exemplary embodiment of the inventive concept may include a user terminal 100, a server 200, and a network 300.

Herein, the wireless communication network environment described below may include at least one of the components shown in FIG. 1. The scope and spirit of the inventive concept may not be limited thereto. For example, the wireless communication network environment according to an exemplary embodiment of the inventive concept may include one or more terminals, one or more servers (e.g., a relay server, a mediation server, and a client server), and one or more networks. The one or more terminals and the one or more servers may connect over different networks.

The user terminal 100 may refer to a device which may communicate a communication signal according to an exemplary embodiment of the inventive concept. It may be interpreted that the user terminal 100 includes all of terminals which may communicate wireless router access information.

In this case, one or more programs or applications may be installed in the user terminal 100. Particularly, an application, including an application program interface (API) or embedded software associated with a system which provides a schedule sharing service between user terminals according to an exemplary embodiment of the inventive concept, may be installed in the user terminal 100.

The user terminal 100 may send or receive data or signals to or from the server 200 for itself or using the one or more installed programs or applications. The sent or received data or signals may be associated with schedule information according to an exemplary embodiment of the inventive concept.

The user terminal 100 may include, for example, at least one of a personal computer (PC), a notebook computer, a tablet PC, a terminal device, a terminal, a mobile station (MS), a mobile subscriber station (MSS), a subscriber station (SS), an advanced motion station (AMS), a wireless terminal (WT), a machine-type communication (MTC) device, a machine-to-machine (M2M) device, or a device-to-device (D2D) device.

Of course, the scope and spirit of the inventive concept may not be limited thereto. For example, it may be appreciated that the user terminal 100 according to an exemplary embodiment of the inventive concept includes all of devices other than the above-mentioned devices, which are currently developed and commercialized or will be developed later, which may send data or signals.

Referring again to FIG. 1, the server 200 may refer to an object which may communicate data with at least one or more other devices through the wireless communication network environment. The server 200 according to an exemplary embodiment of the inventive concept may include a relay server, a mediation server, and/or a client server.

Also, the server 200 may include, for example, at least one of a cloud server, an internet protocol multimedia subsystem (IMS) server, a telephony application server, an instant messaging (IM) server, a media gateway control function (MGCF) server, a messaging gateway (MSG) server, or a call session control function (CSCF) server. The server 200 may be implemented with a device, such as a PC, a notebook computer, and a tablet PC, which may communicate data.

Meanwhile, the network 300 may refer to a data communication network for communicating data between the user terminal 100 and the server 200. Particularly, a type of the network 300 may not be limited.

For example, the network 300 may be an IP network which provides a service for communicating a large amount of data through an IP or an all-IP network in which different IP networks are integrated.

Also, the network 300 may be one of a wired network, a mobile communication network including a wireless broadband (Wibro) network and a wideband code division multiple access (WCDMA) network, a mobile communication network including a high speed downlink packet access (HSDPA) network and a long term evolution (LTE) network, a mobile communication network including an LTE advanced (LTE-A) network and a five generation (5G) network, a satellite communication network, and a wireless-fidelity (Wi-Fi) network or may be a network in which at least one or more of them are combined.

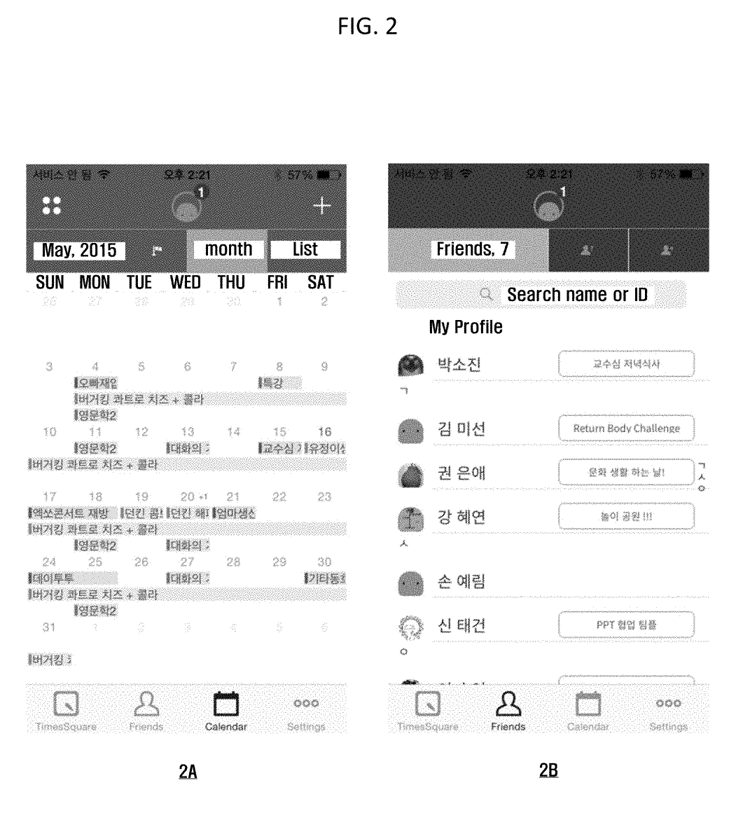

FIGS. 2A and 2B are screens illustrating a schedule sharing application according to an exemplary embodiment of the inventive concept.

Referring to FIGS. 2A and 2B, the schedule sharing application according to an exemplary embodiment of the inventive concept is shown. First of all, as shown in FIG. 2A, the schedule sharing application may include a function of displaying a schedule input from a user on a user terminal in the form of a calendar.

Specifically, the schedule sharing application according to an exemplary embodiment of the inventive concept may display a date and a day of week on a daily basis, on a weekly basis, on a monthly basis, and the like in the form of the calendar. The schedule sharing application may display a schedule input from the user per date on a daily basis, on a weekly basis, and on a monthly basis according to a predetermined method.

In other words, as described above, the schedule sharing application may display a date and a day of week on a monthly basis. Therefore, as shown in FIG. 2A, the schedule sharing application may display a date and a day of week of a specific month (e.g., May 2015) on one screen. In this case, the schedule sharing application may display a schedule, previously input from the user, together per date in May, 2015.

Also, the schedule sharing application according to an exemplary embodiment of the inventive concept may perform a schedule sharing function between user terminals to directly receive a sharing schedule, shared with a plurality of users or a specific user, from a server or another user terminal and to include and display the received sharing schedule in a corresponding date in the calendar.

Meanwhile, as shown in FIG. 2A, the user who installs the schedule sharing application according to an exemplary embodiment of the inventive concept in his or her terminal may enter predetermined information (e.g., a name, an identification (ID) (email), a password, a gender, a date of birth, and the like) and may join the schedule sharing application as a member. The user who joins the schedule sharing application as a member may register at least one or more members as friends in the schedule sharing application.

For example, as shown In FIG. 2B, when a user who has the name of Sojin Part joins the schedule sharing application as a member, the member of Sojin Part may register at least one or more other members (e.g., Mison Kim, Eunae Kwon, Hyeyun Kang, Yelim Son, Taegeon Sin, and the like) as friends. In this case, the member of Sojin Part may directly verify a list of the users registered as the friends using the schedule sharing application.

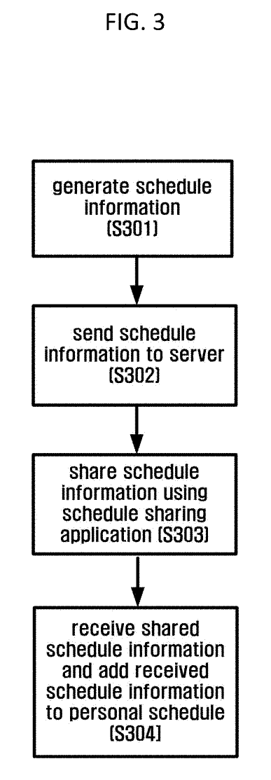

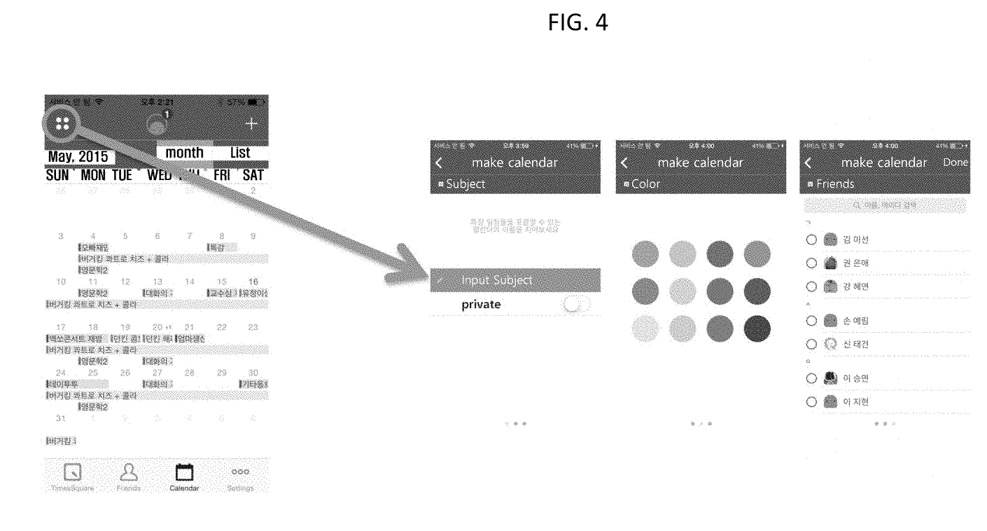

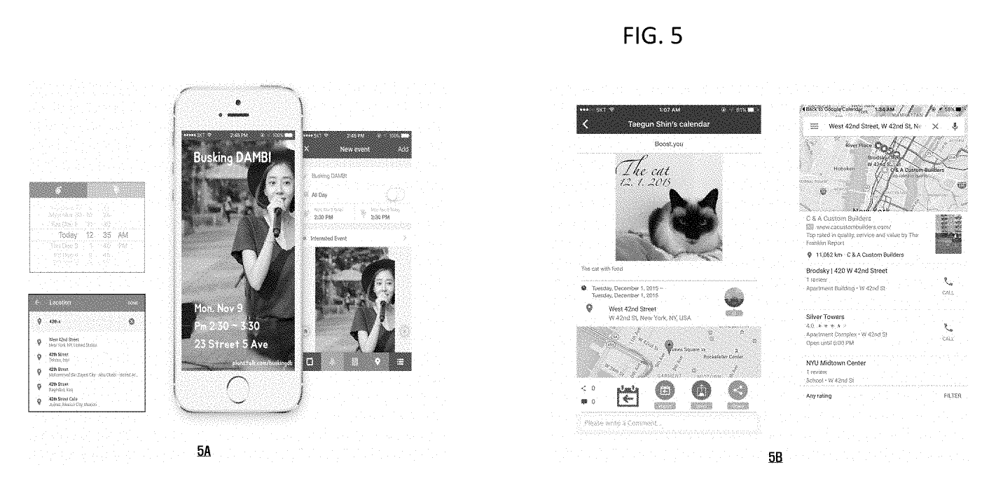

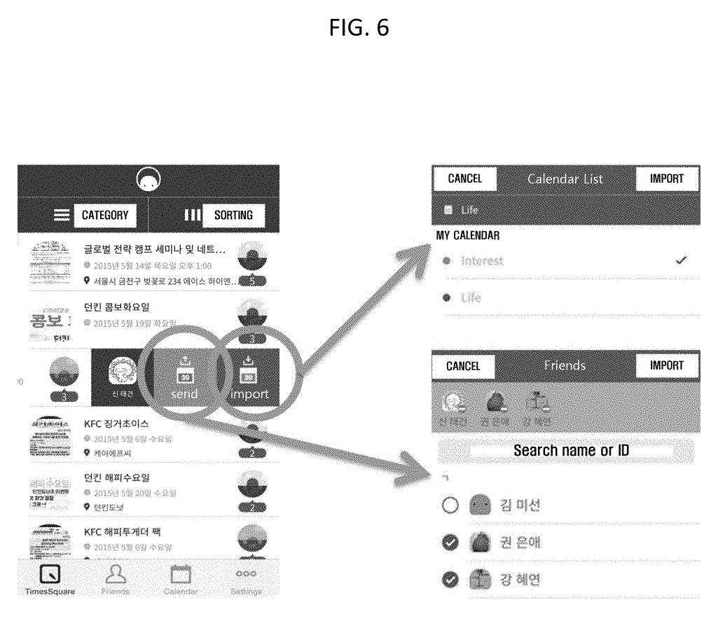

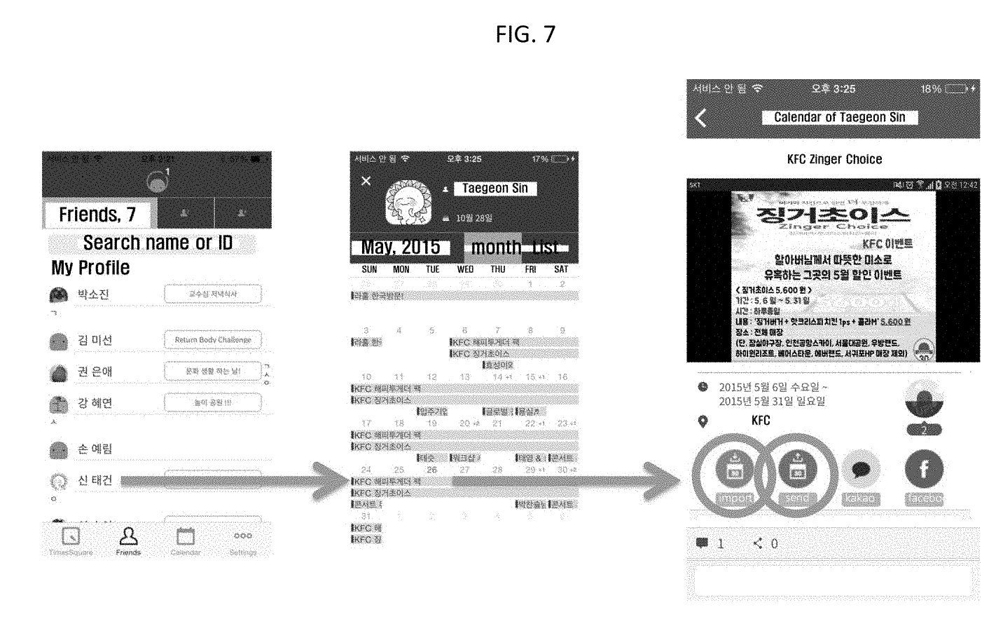

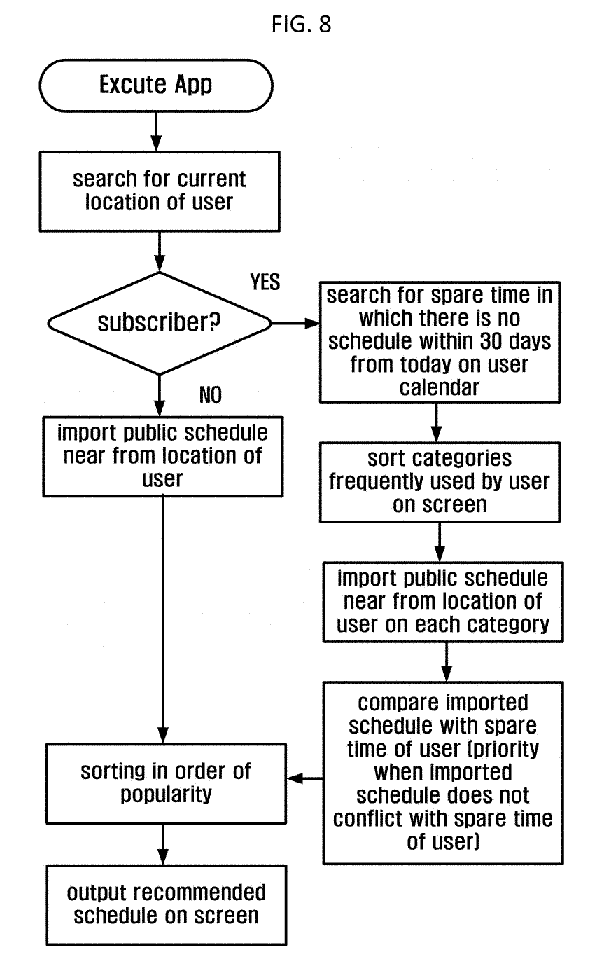

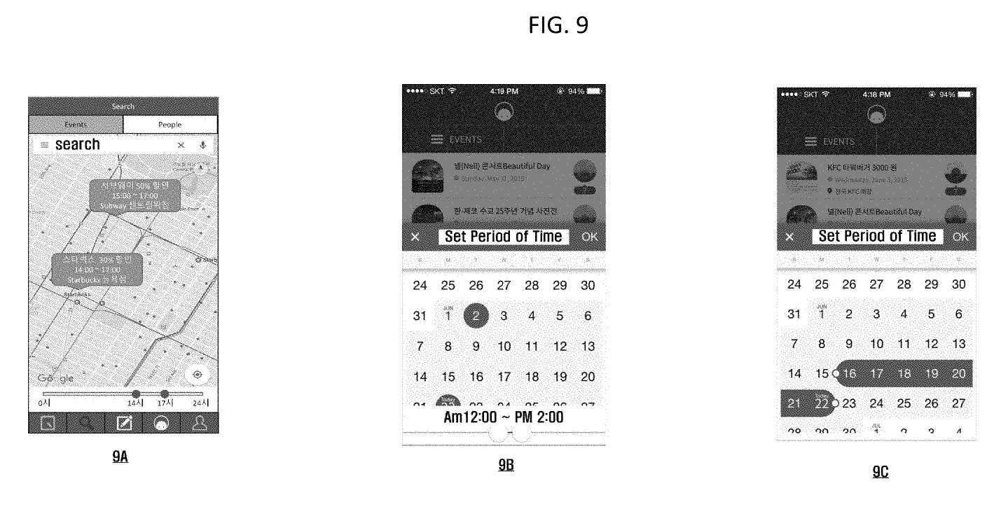

FIG. 3 is a flowchart illustrating a method for providing a schedule sharing service between user terminals using a schedule sharing application according to an exemplary embodiment of the inventive concept. FIG. 4 is a screen illustrating a process of generating schedule information according to an exemplary embodiment of the inventive concept. FIGS. 5A and 5B are screens illustrating a data type of generated schedule information according to an exemplary embodiment of the inventive concept. FIG. 6 is a screen illustrating a method for performing schedule sharing between user terminals by a schedule sharing application according to an exemplary embodiment of the inventive concept. FIG. 7 is a screen illustrating a method for performing schedule sharing between user terminals by a schedule sharing application according to another exemplary embodiment of the inventive concept. FIG. 8 is a flowchart illustrating a method for recommending a schedule shared with a user terminal by a schedule sharing application according to an exemplary embodiment of the inventive concept. FIGS. 9A to 9C are screens illustrating a method for allowing a user to search for a schedule shared with a user terminal by a schedule sharing application according to an exemplary embodiment of the inventive concept.

Referring to FIG. 3, a system which provides a schedule sharing service between user terminals using a schedule sharing application according to an exemplary embodiment of the inventive concept may include a first user terminal, a second user terminal, and a server.

Herein, the system according to an exemplary embodiment of the inventive concept may include, but is not limited to, the first user terminal, the second user terminal, and the server. For example, the system may further include one or more user terminals and one or more servers. The first user terminal and the second user terminal may be the same terminal.

Also, hereinafter, for convenience of description, it is assumed that a schedule sharing application described with reference to FIGS. 2A and 2B is previously installed in each of the first user terminal and the second user terminal.

Referring again to FIG. 3, in step S301, the first user terminal may generate schedule information according to a schedule generation request, input from a user, using the schedule sharing application.

In this case, the schedule generation request input from the user may include, but is not limited to, at least one or more of a schedule title, a schedule display color, information about whether to share a schedule, or information about a user who reserves the right to perform schedule management including schedule correction or deletion.

Herein, the schedule title may refer to detailed contents or a detailed title of a schedule the user wants to enter. The schedule display color may refer to information about whether to display the schedule with any one of predetermined colors on the schedule sharing application. Therefore, the schedule may be distinguished from another schedule. The information about whether to share the schedule may refer to information about whether to share the schedule within any range of users after the user generates the schedule he or she wants to generate (e.g., information about whether to open or share the schedule within any range of the user himself or herself, one or more other users registered as friends in the schedule sharing application by the user, or unspecified users who use the schedule sharing application). In this case, after the schedule is generated, an alarm message is sent to the users corresponding to the range using the schedule sharing application.

Also, the schedule generation request may include information about a user who has the right to manage schedule information uploaded by the user on the schedule sharing application. Herein, the right to manage the schedule information may refer to the right to register, correct, or delete the schedule information. Therefore, another user who does not have the right to manage the schedule information, corresponds to a shared range, and shares the schedule information with the user may perform only verification for the schedule information and may not perform separate management.

For a more detailed example, referring to FIG. 4, when wanting to generate new schedule information to share the schedule information with another user registered as a friend in the schedule sharing application, the user may enter at least one or more of a schedule title, a schedule display color, information about whether to share a schedule, or information about a user who reserves the right to perform schedule management including schedule correction or deletion and may generate the schedule information using the schedule sharing application.

Also, according to an exemplary embodiment of the inventive concept, the schedule information generated according to the above-mentioned method may have a first data type which may interwork with the schedule sharing application previously installed in each of the first user terminal and the second user terminal or a calendar application (or a calendar program) previously installed in each of the first user terminal and the second user terminal.

In this case, the schedule information having the first data type may have, for example, an iCal data type of the iPhone or a Google calendar data type of Android. An exemplary embodiment of the inventive concept may not be limited thereto. For example, the schedule information may be implemented with all kinds of data types which may interwork with a calendar application which is currently developed or will be developed later.

Meanwhile, according to an exemplary embodiment of the inventive concept, the generated schedule information may be implemented with a second data type which is different from the above-mentioned first data type.

In this case, the second data type may have a form in which a specific image and the first data type are combined. Herein, the specific image may include image information which may be included and entered in the schedule generation request by a user of the first user terminal in step S301.

For a more detailed example, referring to FIGS. 5A and 5B, as shown in FIG. 5A, the user of the first terminal may enter a schedule generation request, which further include the specific image together with a schedule generation request which includes at least one or more of a schedule title, a schedule display color, information about whether to share a schedule, or information about a user who reserve the right to manage the schedule, in the first user terminal.

Therefore, as shown in FIG. 5A, image schedule information in which the specific image and each information included in the schedule generation request are combined as one may be generated. In this case, as described above, the image schedule information may be implemented with the second data type.

Also, according to an exemplary embodiment of the inventive concept, the one image schedule information may be expressed as one uniform resource locator (URL) information. Therefore, when wanting to share the generated image schedule information with another user in the schedule sharing application or another external user through a social network service (SNS) or a messenger, and the like, the user may share the generated image schedule information with the other user by sending the URL information to the other user.

The image schedule information implemented with the second data type may be implemented with a form in which the specific image includes a schedule title, date information, time information, and place information included in the schedule generation request. As shown in FIG. 5B, the image schedule information may further include a map image associated with the place information included in the specific image to be displayed.

Referring again to FIG. 3, after generating the schedule information (including image schedule information) through the above-mentioned method, in step S302, the first user terminal may send the generated schedule information to the server. After receiving the generated schedule information from the first user terminal, in step S303, the server may share the received schedule information with at least one or more user terminals, in which the schedule sharing application is installed, using the schedule sharing application.

In this case, the sharing of the received schedule information may be achieved according to information, about whether to share a schedule entered by the user in the process of generating the schedule information. For example, when the information about whether to share the schedule is set to verify a schedule entered by the user by only the user himself or herself, the schedule information uploaded to the server to be shared may not be shared with another user in the schedule sharing application.

When the information about whether to share the schedule is set to be verified by other users registered as friends by the user in the schedule sharing application or by some of the other users or when the information about whether to share the schedule is set to be verified by unspecified users who use the schedule sharing application, the schedule information may be shared with the other users, some of the other users, or the unspecified users.

Meanwhile, when the server shares the schedule information with the second user terminal using the schedule sharing application, in step S304, a user of the second user terminal in which the schedule sharing application is previously installed may verify the shared schedule information, may receive desired schedule information, and may add the received schedule information to his or her schedule.

For a more detailed example, referring to FIG. 6, the user of the second user terminal may import specific schedule information to be added to his or her schedule among schedule information shared by the schedule sharing application from the server. In this case, the imported specific schedule information may be added to a schedule of the second user terminal (or the user of the second user terminal) by the schedule sharing application or another calendar application (or a calendar program) previously installed in the second user terminal.

Also, according to an exemplary embodiment of the inventive concept, the user of the second user terminal may send specific schedule information among the schedule information shared by the schedule sharing application to another user registered as a friend in the schedule sharing application. In this case, after receiving the specific schedule information, the other user may verify the fact about the reception through alarm information.

Meanwhile, according to an exemplary embodiment of the inventive concept, direct schedule sharing between user terminals may be performed by the schedule sharing application.

In other words, as shown in FIG. 7, the user of the first user terminal may directly send schedule information, generated according to the method described with reference to step S301, to the second user terminal using the schedule sharing application. In this case, when the second user terminal receives the schedule information, the schedule information generated by the first user terminal may be directly shared with the second user terminal to be distinguished from the above-mentioned method of receiving the schedule information through the server.

In this case, steps S302 and S303 may be omitted. Therefore, direct schedule sharing between the first user terminal and the second user terminal may be performed. Also, when the second user terminal receives the schedule information from the first user terminal, the user of the second user terminal may verify the fact about the reception through alarm information, may then receive the schedule information, and may add the received schedule information to his or her schedule.

Also, according to an exemplary embodiment of the inventive concept, the user of the first user terminal may send the generated schedule information to other users (herein, the other users may include users who join the schedule sharing application as members) who do not join the schedule sharing application as members through several methods, such as an SNS, a text message, an e-mail, a mobile messenger, and a web browser, for communicating data and may share the generated schedule information with the other users.

In this case, the schedule information shared with the other users may include the above-mentioned image schedule information. When shared schedule information is image schedule information, the sharing may be achieved in the form of sending a URL address indicating the image schedule information and/or sending a specific image indicating the image schedule information. An exemplary embodiment of the inventive concept may not be limited thereto.

Also, the other users who do not join the schedule sharing application as members may verify the schedule information through an SNS, a text message, an e-mail, a mobile messenger, a web browser, and the like used to share the schedule information by the first user terminal. Thereinafter, the other users may receive desired schedule information and may add the received schedule information to his or her schedule through a calendar application (or a calendar program) previously installed in each of user terminals of the other users (or through the schedule sharing application when the schedule sharing application is newly installed in each of user terminals of the other users).

Meanwhile, according to an exemplary embodiment of the inventive concept, the schedule sharing application may perform recommendation of at least one or more of one or more schedule information shared by the schedule sharing application to a user terminal.

In this case, the recommendation may be achieved according to at least one or more of current location information of the user terminal (or a user of the user terminal), preference schedule category information (e.g., a variety of schedule related categories, such as a play, a movie, and a performance, which are preset or are input by the user) previously selected or input by the user of the user terminal, or blank schedule information indicating a time or date in which any of schedules of the user of the user terminal is not established. Therefore, determined recommendation schedule information may be provided to the user terminal.

In other words, referring to FIG. 8, the schedule sharing application may consider a current location of a user terminal (or a user of the user terminal) and may select specific schedule information which has place information within a predetermined range from the current location of the user terminal among one or more schedule information shared by the schedule sharing application.

Thereafter, the schedule sharing application may verify whether the user terminal joins the schedule sharing application as a member. If the user terminal does not join the schedule sharing application as a member, the schedule sharing application may recommend the schedule information selected according to the location of the user terminal to the user terminal.

In this case, the selected schedule information may be recommended to the user terminal in descending or ascending order according to the order of having higher popularity among users in the schedule sharing application.

Meanwhile, if the user terminal joins the schedule sharing application as a member, the user of the user terminal may consider a blank schedule in which there is no schedule within a range of a predetermined period of time among schedules previously entered in the schedule sharing application (e.g., a range of a specific date or a specific time in which there is no schedule within a range of 30 days), a schedule category the user of the user terminal prefers, and current location information of the user terminal in a predetermined order or may consider all of them once, and determine recommendation information among the selected schedule information.

Meanwhile, according to an exemplary embodiment of the inventive concept, the schedule sharing application may analyze preference schedule category information previously selected by the user of the user terminal or schedule information input or received using the schedule sharing application by him or her in a quantitative or qualitative way and may recommend schedule information, linked with a preference schedule category of the user, among one or more schedule information shared by the schedule sharing application to him or her according to the drawn preference schedule category information (e.g., a variety of schedule related categories such as a play, a movie, and a performance).

Also, in this case, the schedule sharing application may recommend all of schedule information linked with a preference schedule category of the user among schedule information shared by the schedule sharing application to the user. In contrast, the schedule sharing application may verify blank schedule information, indicating a time or date in which any schedule is not established, through schedule information previously input or added in the schedule sharing application of the user. The schedule sharing application may compare schedule information linked with a preference schedule category of the user with the blank schedule information, may additionally select only information about a schedule in which the user may participate without conflicting with another schedule among the schedule information linked with the preference schedule category of the user, and may recommend the selected schedule information to the user.

Meanwhile, according to an exemplary embodiment of the inventive concept, the user of the user terminal may perform a separate search method for one or more schedule information shared by the schedule sharing application.

In this case, the search method may include a method of searching for schedule information including a specific keyword entered from the user of the user terminal among the one or more schedule information, a method of searching for schedule information having a time range corresponding to a predetermined time range entered by the user of the user terminal, and a method of searching for schedule information shared with a specific user entered by the user of the user terminal. However, an exemplary embodiment of the inventive concept may not be limited thereto. For example, a search method may be performed according to various methods in which a predetermined user may search for schedule information.

For a more detailed example, referring to FIGS. 9A to 9C, as shown in FIG. 9A, the user may search for schedule information within a predetermined range according to his or her location among schedule information shared by the schedule sharing application. Additionally or alternatively, the user may enter a predetermined time range using a time bar or may directly enter the predetermined time range, and may search for predetermined schedule information corresponding to the predetermined time range.

Also, as shown in FIGS. 9B and 9C, the user may select a range of a specific date or a specific period of time and may search for schedule information within the selected range of the specific date or the specific period of time.

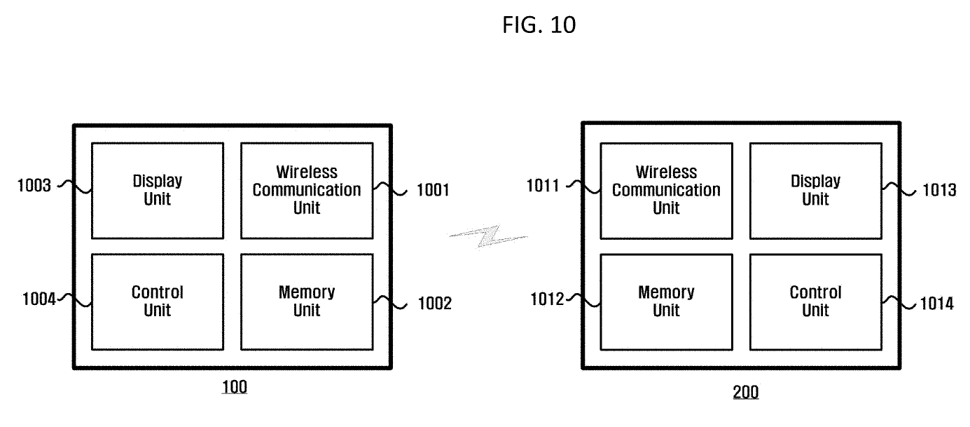

FIG. 10 is a block diagram illustrating a configuration of a user terminal and a configuration of a server according to an exemplary embodiment of the inventive concept.

Referring to FIG. 10, a user terminal 100 and a server 200 are shown according to an exemplary embodiment of the inventive concept. In FIG. 10, an exemplary embodiment of the inventive concept may be exemplified as only the one user terminal 100 and the one server 200. However, the scope and spirit of the inventive concept may not be limited thereto. For example, one or more user terminals and one or more servers may be included.

The server 200 may include, but is not limited to, a wireless communication unit 1011, which includes a transmitter and a receiver which may communicate schedule information, a memory unit 1012, a display unit 1013, and a control unit 1014 (or a processor). For example, the server 200 may further include other components other than the components shown in FIG. 10. Alternatively, some of the components shown in FIG. 10 may be omitted from the sever 200.

Also, an overall process, such as signal processing and layer processing of the server 200, for data communication with the user terminal 100 may be controlled by the memory 1012 and the control unit 1014. A connection relationship may be established between the memory 1012, the wireless communication unit 1011, and the control unit 1014.

As described above, the wireless communication unit 1011 included in the server 200 may include the transmitter and the receiver. The transmitter and the receiver may be configured to transmit and receive data or signals between the user terminal 100 and the server 200.

The control unit 1014 may be configured to be functionally connected with the transmitter and the receiver in the wireless communication unit 1011 and to control a process of transmitting and receiving data or signals between the user terminal 100 and the server 200. Also, the control unit 1014 may perform a variety of processing of data to be transmitted, may transmit the processed data to the transmitter, and may process data received by the receiver.

If necessary, the control unit 1014 may store information included in the transmitted and received data in the memory 1012. The server 200 having the above-mentioned components may perform methods described with reference to FIGS. 1 to 9C according to various exemplary embodiments of the inventive concept.

Referring to the user terminal 100 of FIG. 10, a wireless communication unit 1001 including a transmitter and receiver of the user terminal 100 may be configured to transmit and receive data or signals with the server 200.

Also, a control unit 1004 of the user terminal 100 may be configured to be functionally connected with the transmitter and the receiver of the wireless communication unit 1001 and to control a process in which the transmitter and the receiver transmit and receive data or signals with other devices which include the server 200.

Also, the user terminal 100 may include a display 1003, which displays shared schedule information received from the server 200, inside or outside of the user terminal 100.

The display 1003 may output information processed by the user terminal 100. Specifically, the display unit 1003 may display a schedule sharing application, schedule information, and the like using a user interface (UI) or a graphic user interface (GUI).

In addition, the display unit 1003 may include at least one of a liquid crystal display (LCD), a thin film transistor-LCD (TFT-LCD), an organic light-emitting diode (OLED), a flexible display, or a three-dimensional (3D) display.

There may be two or more display units according to an implemented form. For example, the user terminal 100 may simultaneously include an external display unit and an internal display unit.

Meanwhile, the control unit 1004 may perform a variety of processing of data or signals to be transmitted, may transmit the processed data or signals to the transmitter, and may process data or signals received by the receiver.

If necessary, the control unit 1004 may store information, included in the transmitted and received data, in the memory 1003.

The control unit 1004 of the user terminal 100 and the control unit 1014 of the server 200 may instruct (e.g., control, adjust, manage, and the like) operations of the user terminal 100 and the server 200, respectively. The control units 1004 and 1014 may connect with the memories 1002 and 1012, each of which stores program codes and data, respectively.

The memories 1002 and 1012 may connect with the control units 1004 and 1014, respectively, and may store an operating system, an application, and general files.

Each of the control units 1004 and 1014 may be referred to as a controller, a microcontroller, a microprocessor, a microcomputer, and the like. Meanwhile, each of the control units 1004 and 1014 may be implemented with hardware, firmware, software, or combinations thereof.

When being implemented with firmware or software, each of the control units 1004 and 1014 may be implemented in the form of a module, procedure, function, or the like which performs the above-described functions or operations according to an exemplary embodiment of the inventive concept. Software codes may be stored in each of the memories 1002 and 1012 and may be executed by each of the control units 1004 and 1014. The memories 1002 and 1012 may be located inside or outside the user terminal 100 and the server 200, respectively. The memories 1002 and 1012 may transmit and receive data with the control unit 1004 and 1014, respectively, by various well-known means.

Meanwhile, the above-described methods may be written by a computer-executable program and may be implemented in a general purpose digital computer which operates the program using a computer-readable storage media. Also, a structure of data used in the above-described methods may be recorded in the computer-readable storage media through several means. The computer-readable storage media which store executable computer codes for performing various methods according to various exemplary embodiments of the inventive concept may include storage media such as magnetic media (e.g., a read only memory (ROM), a floppy disc, a hard disc, and the like), optical media (e.g., a compact disc read only memory (CD-ROM) and a digital versatile disc (DVD)).

According to various exemplary embodiments of the inventive concept, the system may provide the schedule sharing service between the user terminals using the schedule sharing application.

According to various exemplary embodiments of the inventive concept, the schedule sharing system may recommend a related schedule within a predetermined range from the location of the user among schedules shared by the schedule sharing application to him or her.

According to various exemplary embodiments of the inventive concept, the schedule sharing system may search for a corresponding shared schedule among schedules shared by the schedule sharing application according to a keyword, a time range, and the like entered by the user.

It should be understood those skilled in the art that various changes and modifications may be made without departing from the spirit and scope of the inventive concept. Therefore, it should be considered that the above embodiments are not limiting, but illustrative. The scope of the inventive concept is defined by the following claims rather than the foregoing detailed description, and it should be interpreted that all modifications and changes from the meaning, scope and equivalents of the claims are included in the scope and the inventive concept.

### INDUSTRIAL APPLICABILITY

A system for providing a schedule sharing service between user terminals using a schedule sharing application may be applied to various systems which provide the schedule sharing service.

What is claimed is:

1. A system for performing schedule sharing between user terminals using a schedule sharing application, the system comprising:
a first user terminal configured to generate schedule information according to a schedule generation request input from a user of the first user terminal and to transmit and upload the generated schedule information using the schedule sharing application;
a server configured to share the uploaded schedule information with one or more user terminals using the schedule sharing application; and
a second user terminal configured to receive the shared schedule information using the schedule sharing application and to add the received schedule information to a schedule of a user of the second user terminal.

2. The system of claim 1, wherein the generated schedule information has a first data type which interworks with a calendar application or the schedule sharing application previously installed in each of the first and second user terminals.

3. The system of claim 2, wherein the generated schedule information has a second data type in which a specific image entered by the user of the first user terminal is combined with the first data type.

4. The system of claim 3, wherein the generated schedule information having the second data type comprises at least one or more of a schedule title, date information, time information, or place information included in the schedule generation request, and
wherein the generated schedule information having the second data type further comprises a map image associated with the place information.

5. The system of claim 4, wherein the schedule generation request comprises at least one or more of a schedule title, a schedule display color, information about to share a schedule, or information about a user who reserves the right to perform schedule management including schedule correction or deletion.

6. The system of claim 1, wherein the user of the second user terminal performs a search for one or more schedule information shared by the schedule sharing application, and
wherein the search is one of a search for schedule information including a specific keyword entered by a user of the second user terminal among the one or more schedule information, a search for schedule information having a time range corresponding to a predetermined time range entered by the user of the second user terminal, and a search for schedule information shared with a specific user entered by the user of the second user terminal.

7. The system of claim 1, wherein the schedule sharing application performs recommendation, for at least one or more of one or more schedule information shared by the schedule sharing application, to the second user terminal, and
wherein the recommendation is to provide schedule information, determined according to at least one or more of current location information of the user of the second user terminal, preference schedule category information of the user of the second user terminal, or blank schedule information of the user of the second user terminal, among the one or more shared schedule information to the second user terminal.

8. The system of claim 3, wherein the first user terminal directly performs schedule sharing with the second user terminal by transmitting the generated schedule information to the second user terminal using the schedule sharing application.

9. The system of claim 3, wherein the first user terminal performs schedule sharing with at least one or more other user terminals by transmitting the generated schedule information to each of the at least one or more other user terminals, and
wherein each of the at least one or more other user terminals receives the shared schedule information and displays the received schedule information to the user of the first user terminal using the schedule sharing application or the calendar application previously installed in each of the first and the second user terminals.

10. A method for performing schedule sharing between user terminals using a schedule sharing application, the method comprising:
generating, by a first user terminal, schedule information according to a schedule generation request input from a user of the first user terminal;
transmitting and uploading, by a first user terminal, the generated schedule information to a server using the schedule sharing application;
sharing, by the server, the uploaded schedule information with one or more user terminals using the schedule sharing application; and
receiving, by a user of a second user terminal among the one or more user terminals, the shared schedule information using the schedule sharing application and adding, by the user of the second user terminal, the received schedule information to a schedule of the user of the second user terminal.
